(19) United States
(12) Patent Application Publication
(10) Pub. No.: US 2026/0067299 A1
(43) Pub. Date: Mar. 5, 2026

(54) SYSTEM AMD METHOD FOR DETECTING SECURITY BREACH IN AVIONICS NETWORK

(71) Applicant: Honeywell International Inc., Charlotte, NC (US)

(72) Inventors: Anand Anand Arjunan, Karnataka (IN); Gobinathan Baladhandapani, Madurai (IN)

(21) Appl. No.: 18/937,090

(22) Filed: Nov. 5, 2024

(30) Foreign Application Priority Data
Sep. 2, 2024 (IN) 202411066213

(51) Int. Cl. H04L 9/40

(52) U.S. Cl. CPC H04L 63/1416

(57) ABSTRACT

A method for detecting security breach in avionics network is disclosed. The method comprises generating a signal corresponding to avionics network for each source end with a predefined timestamp; transmitting the signal from each source end to each destination end with the predefined timestamp via virtual links; determining whether the signal received by each destination end is at the predefined timestamp; determining whether the message signature associated with the signal received by each destination end is valid, upon determining the signal received by each destination end is at the predefined timestamp; determining whether an error count of errors exceeds a predefined threshold value upon determining the message signature is not valid or upon determining the signal received by each destination end is not at the predefined timestamp; and generating an alert associated with the errors upon determining the error count exceeds the predefined threshold value, for a user.

### TECHNOLOGICAL FIELD

Example embodiments of the present disclosure generally relates to aerospace electronics, and more particularly relates to a system and a method for detecting security breach in avionics network.

### BACKGROUND

Avionics systems in modern aircraft are highly sophisticated and designed to ensure utmost safety and reliability during flight operations. The avionics systems interact in a deterministic manner, meaning that every communication between components is scheduled, with a source and destination of each message predetermined. Such ensures that avionics network operates smoothly and efficiently under normal conditions. However, the messages exchanged within the avionics network are typically in clear text and follow predefined structures, which means that if someone gains physical access to the avionics network, they can easily read, alter, or inject malicious messages. The unauthorized access and manipulation poses a significant security risk, as the unauthorized access can directly impact the safety of the flight.

Despite high design assurance levels (DAL) that avionics software must comply with, which ensures a high level of reliability and robustness, the avionics systems is not inherently equipped to handle physical security breaches effectively. While the avionics systems are designed to process and handle data efficiently under normal operations, any intrusion requires the avionics systems to expend valuable resources managing unexpected and potentially malicious packets. The intrusion can disrupt normal operations and jeopardize the flight safety. Such reliance on physical security measures to prevent unauthorized access is a critical vulnerability, highlighting the need for more robust security measures within the avionics systems to safeguard against the intrusions.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method for detecting security breach in avionics network is disclosed. The method comprises generating, via at least one processor, a signal corresponding to avionics network for each source end with a predefined timestamp. The signal corresponds to a health signal of the avionics network and having one or more parameters. The one or more parameters comprise at least one of a virtual link identifier (ID), a signal ID, and a message signature. The method further comprises transmitting, via the at least one processor, the signal from each source end to each destination end with the predefined timestamp via one or more virtual links. The method further comprises determining, via the at least one processor, whether the signal received by each destination end is at the predefined timestamp. The predefined timestamp corresponds to a source time at which the signal for each source end is generated. Further, the method comprises determining, via the at least one processor, whether the message signature associated with the signal received by each destination end is valid, upon determining the signal received by each destination end is at the predefined timestamp. Further, the method comprises determining, via the at least one processor, whether an error count of one or more errors exceeds a predefined threshold value upon determining the message signature associated with the signal received by each destination end is not valid or upon determining the signal received by each destination end is not at the predefined timestamp. The predefined threshold value corresponds to a maximum number of errors allowable within the avionics network. Thereafter, the method comprises generating, via the at least one processor, an alert associated with the one or more errors upon determining the error count of the one or more errors exceeds the predefined threshold value, for a user.

In some embodiments, the method further comprises generating, via the at least one processor, another signal for each source end having one or more parameters, upon determining the message signature associated with the signal received by each destination end is valid.

In some embodiments, the method further comprises logging, via the at least one processor, one or more entries associated with the one or more errors and incrementing the error count, upon determining the error count of the one or more errors does not exceeds the predefined threshold value.

In some embodiments, the method further comprises transmitting, via the at least one processor, the alert associated with the one or more errors to the user, wherein the user corresponds to a pilot or a ground support unit. In some embodiments, the alert comprises one or more instructions such as follow standard operating procedure (SOP) and initiate inspection.

In some embodiments, the method further comprises identifying, via the at least one processor, each source end and each destination end within the avionics network with one or more deterministic traffic capabilities. Further, the method comprises identifying, via the at least one processor, a communication scheme, at least one type for each source end and each destination end, and a critical traffic virtual links for each source end and each destination end. Thereafter, the method comprises adding, via the at least one processor, at least one slot in each source end to transmit the signal with the predefined timestamp and at least one slot in each destination end to receive the signal at the predefined timestamp.

In some embodiments, the at least one slot in each source end and the at least one slot in each destination end correspond to a specific time interval, logical channel, or frequency range during which the signal is configured to be transmitted from the source end to the destination end. In some embodiments, the source end and the destination end in the avionics network correspond to one or more origins and one or more target points of data communication or signal transmission within the avionics network.

In another example embodiment, a system for detecting security breach in avionics network is disclosed. The system comprises a memory and at least one processor communicatively coupled to the memory. The at least one processor is configured to generate a signal corresponding to avionics network for each source end with a predefined timestamp. The signal corresponds to a health signal of the avionics network and having one or more parameters. The one or more parameters comprise at least one of a virtual link identifier (ID), a signal ID, and a message signature. The at least one processor is further configured to transmit the signal from each source end to each destination end with the predefined timestamp via one or more virtual links. Further, the at least one processor is configured to determine whether the signal received by each destination end is at the predefined timestamp. The predefined timestamp corresponds to a source time at which the signal for each source end is generated. The at least one processor is further configured to determine whether the message signature associated with the signal received by each destination end is valid, upon determining the signal received by each destination end is at the predefined timestamp. Further, the at least one processor is configured to determine whether an error count of one or more errors exceeds a predefined threshold value upon determining the message signature associated with the signal received by each destination end is not valid or upon determining the signal received by each destination end is not at the predefined timestamp. The predefined threshold value corresponds to a maximum number of errors allowable within the avionics network. Thereafter, the at least one processor is configured to generate an alert associated with the one or more errors upon determining the error count of the one or more errors exceeds the predefined threshold value, for a user.

In another example embodiment, a non-transitory machine-readable information storage medium for detecting security breach in avionics network is disclosed. The non-transitory machine-readable information storage medium comprises one or more instructions which when executed by at least one processor cause the at least one processor to generate a signal corresponding to avionics network for each source end with a predefined timestamp, wherein the signal corresponds to a health signal of the avionics network and having one or more parameters, wherein the one or more parameters comprise at least one of a virtual link identifier (ID), a signal ID, and a message signature; transmit the signal from each source end to each destination end with the predefined timestamp via one or more virtual links; determine whether the signal received by each destination end is at the predefined timestamp, wherein the predefined timestamp corresponds to a source time at which the signal for each source end is generated; determine whether the message signature associated with the signal received by each destination end is valid, upon determining the signal received by each destination end is at the predefined timestamp; determine whether an error count of one or more errors exceeds a predefined threshold value upon determining the message signature associated with the signal received by each destination end is not valid or upon determining the signal received by each destination end is not at the predefined timestamp, wherein the predefined threshold value corresponds to a maximum number of errors allowable within the avionics network; and generate an alert associated with the one or more errors upon determining the error count of the one or more errors exceeds the predefined threshold value, for a user.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for detecting security breach in avionics network in accordance with an example embodiment of the present disclosure;

FIG. 2 illustrates a block diagram of a server in accordance with an example embodiment of the present disclosure;

FIG. 3 illustrates transmission of a signal from each source end to each destination end via one or more virtual links in accordance with an example embodiment of the present disclosure;

FIG. 4 illustrates a flowchart showing a design time configuration of the avionics network in accordance with an example embodiment of the present disclosure;

FIG. 5 illustrates a flowchart showing a run-time configuration of the avionics network in accordance with an example embodiment of the present disclosure;

FIG. 6 illustrates one or more components of the avionics network of an aircraft in accordance with an example embodiment of the present disclosure;

FIG. 7 illustrates a database for a health signal of the avionics network for the aircraft in accordance with an example embodiment of the present disclosure;

FIG. 8 illustrates an error database within the avionics network of the aircraft in accordance with an example embodiment of the present disclosure; and

FIG. 9 illustrates a flowchart showing a method for detecting security breach in the avionics network in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of methods and systems for detecting security breach in avionics network of an aircraft. Embodiments may be configured to generate a signal corresponding to an avionics network for each source end with a predefined timestamp. The signal may correspond to a health signal of the avionics network and may have one or more parameters. The one or more parameters may comprise at least one of a virtual link identifier (ID), a signal ID, and a message signature. Embodiments may be configured to transmit the signal from each source end to each destination end with the predefined timestamp via one or more virtual links. Embodiments may be further configured to determine whether the signal received by each destination end may be at the predefined timestamp. The predefined timestamp may correspond to a source time at which the signal for each source end may be generated.

Further, embodiments may be configured to determine whether the message signature associated with the signal received by each destination end may be valid, upon determining the signal received by each destination end may be at the predefined timestamp. Further, embodiments may be configured to determine whether an error count of one or more errors may exceed a predefined threshold value upon determining the message signature associated with the signal received by each destination end may not be valid or upon determining the signal received by each destination end may not be at the predefined timestamp. The predefined threshold value may correspond to a maximum number of errors allowable within the avionics network. Further, embodiments may be configured to generate an alert associated with the one or more errors upon determining the error count of the one or more errors exceeds the predefined threshold value, for a user.

Embodiments may be configured to generate another signal for each source end having one or more parameters, upon determining the message signature associated with the signal received by each destination end may be valid. Further, the embodiments may be configured to log one or more entries associated with the one or more errors and incrementing the error count, upon determining the error count of the one or more errors may not exceed the predefined threshold value. Further, embodiments may be configured to transmit the alert associated with the one or more errors to the user. The user may correspond to a pilot or a ground support unit.

Embodiments may be configured to identify each source end and each destination end within the avionics network with one or more deterministic traffic capabilities. Embodiments may be configured to identify a communication scheme, at least one type for each source end and each destination end, and a critical traffic virtual links for each source end and each destination end. Further, embodiments may be configured to add at least one slot in each source end to transmit the signal with the predefined timestamp and at least one slot in each destination end to receive the signal at the predefined timestamp. The at least one slot in each source end and the at least one slot in each destination end may correspond to a specific time interval, logical channel, or frequency range during which the signal may be configured to be transmitted from the source end to the destination end.

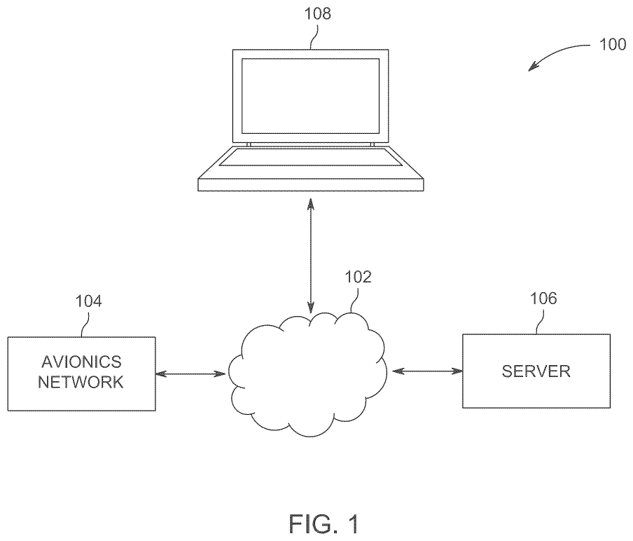

FIG. 1 illustrates a network diagram of a system 100 for detecting security breach in an avionics network 104, in accordance with an example embodiment of the present disclosure. The system 100 may comprise a network 102 communicatively coupled to the avionics network 104 (i.e., avionics system), a server 106, and a user device 108.

In some embodiments, the network 102 may be a communication network such as internet or a cloud network, that may be configured to allow the avionics network 104, the server 106, and the user device 108 to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms through wired devices. Those skilled in the art will recognize that the wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

Further, the system 100 may comprise the avionics network 104. In some embodiments, the avionics network 104 may be an electronic system used on the aircraft, artificial satellites, and spacecraft designed for navigation, communication, and management of on-board systems. The avionics network 104 may provide a user information and control capabilities necessary to ensure safe and efficient aircraft operations. The user may correspond to a pilot, a flight crew, or a ground support unit. The avionics network 104 may comprise one or more components. The one or more components may correspond to each source end and each destination end. The one or more components may comprise a Flight Management System (FMS), an Automatic Flight Control System (AFCS), a navigation system, a communication system, a display system, a weather radar system, a Traffic Collision Avoidance System (TCAS), an Engine Indicating and Crew Alerting System (EICAS), a Passenger Address and Cabin Intercommunication System, a fuel management system, and a Landing Gear and Brake Control System.

In some embodiments, the server 106 may be a computer or software module that is configured to provide centralized resources, data, or services to the user device 108 operated by the user. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network administrators to configure, monitor, and maintain network resources, security settings, and user access permissions from a single location.

In some embodiments, the server 106 may comprise a memory (not shown), and at least one processor (not shown). The at least one processor may be communicatively coupled to the memory. In some embodiments, the server 106 may be configured to generate a signal corresponding to the avionics network 104 for each source end with the predefined timestamp. The signal may be generated for continuous monitoring and validation of the avionics network's health and operational status. Further, each generated signal may be assigned the predefined timestamp to ensure precise tracking and synchronization of the avionics network 104. The predefined timestamp may record exact source time when the signal may be generated. Further, the predefined timestamp may serve as a temporal reference that may be crucial for maintaining synchronization across the avionics network 104.

In some embodiments, the signal corresponding to the avionics network 104 may be generated at run-time. The signal may correspond to the health signal of the avionics network 104 and having the one or more parameters. The one or more parameters may comprise at least one of the virtual link identifier (ID), the signal ID, and the message signature. In some embodiments, the virtual link ID may uniquely identify the one or more virtual links (VL) through which the signal may be transmitted. Each of the one or more virtual links may represent a dedicated communication path within the avionics network 104. The one or more virtual links may ensure that the generated signal may follow a predefined route.

Further, the server 106 may be configured to transmit the signal from each source end to each destination end with the predefined timestamp via the one or more virtual links. The signal may be transmitted from each source end to each destination end via the one or more virtual links upon generating the signal with the predefined timestamp. In some embodiments, the sever 106 may select the appropriate one or more virtual links for the signal based at least on communication requirements. Each of the one or more virtual links may be a unique pathway that may connect each source end to each destination end. Further, the signal, accompanied by the predefined timestamp, may be transmitted through the selected one or more virtual links. The one or more virtual links may ensure that the signal may follow a specific, pre-established route within the avionics network 104. Selection of the one or more virtual links may minimize risk of the signal collision or interference. In some embodiments, the generated signal may be transmitted from each source end to each destination end via the one or more virtual links at a predefined interval without hampering the signal transmitting in the avionics network 104 of the aircraft.

In some embodiments, the server 106 may be configured to identify each source end and each destination end within the avionics network 104 with one or more deterministic traffic capabilities. The one or more deterministic traffic capabilities may refer to the ability of the avionics network 104 to handle the signal transmission in a highly predictable manner. The server 106 may be configured to identify each source end within the avionics network 104. Each source end may be the origin point of the signals. Identification of each source end may involve recognizing the one or more parameters associated with each source end. Similarly, the server 106 may identify each destination end within the avionics network 104. Each destination end may be the point where the signal may be intended to be received. Identification of each destination end may include acknowledging the one or more parameters tied to each destination end. The one or more parameters may comprise at least one of the virtual link identifier (ID), the signal ID, and the message signature.

Further, the server 106 may be configured to identify a communication scheme, at least one type for each source end and each destination end, and a critical traffic virtual links for each source end and each destination. In some embodiments, the server 106 may be configured to identify the communication scheme utilized by each source end and each destination end. The communication scheme may refer to the set of protocols, rules, and structures that govern the transmission of the signals within the avionics network 104. Within the communication scheme, there may be various types of communication, each serving different purposes and adhering to different protocols.

In some embodiments, the server 106 may identify the critical traffic virtual links for each source end and each destination end. The virtual links may be logical connection within the avionics network 104 that may define the path the signal may take from each source end to each destination end. In some embodiments, not all the virtual links are equal, some virtual links may carry more critical signal than others. The server 106 may identify which virtual links may be designated for critical traffic. The critical data may correspond to the data that may be vital for safe and efficient operation of the aircraft.

In some embodiments, by identifying the communication scheme for each source end and each destination end, along with the critical traffic virtual links, the server 106 may ensure that the communication may occur at the predefined timestamp and may follow predetermined pathways.

Further, the server 106 may be configured to add at least one slot in each source end to transmit the signal with the predefined timestamp and at least one slot in each destination end to receive the signal at the predefined timestamp. The at least one slot in each source end and the at least one slot in each destination end may correspond to a specific time interval, logical channel, or frequency range during which the signal may be configured to be transmitted from each source end to each destination end. Each source end and each destination end in the avionics network 104 may correspond to one or more origins and one or more target points of data communication or signal transmission within the avionics network 104, respectively.

In some embodiments, the server 106 may be configured the to add at least one slot in each source end. The at least one slot may correspond to the predefined time interval, the logical channel, or the frequency range allocated specifically for transmitting the signal with the predefined timestamp. The at least one slot may ensure that each source end may transmit the signal in a synchronized and orderly manner, reducing the risk of data collision or interference. Further, the server 106 may add the at least one slot in each destination end. The at least one slot may correspond to the predefined time interval, the logical channel, or the frequency range during which each destination end may be configured to receive the signal. The at least one slot may ensure that each destination end may be ready to process the incoming signal at the predefined timestamp, maintaining temporal integrity of the communication.

In some embodiments, the server 106 may further be configured to determine whether the signal received by each destination end is at the predefined timestamp. The server 106 may determine whether the received signal's timestamp may match the predefined timestamp. The server 106 may compare the received signal's timestamp with the predefined timestamp that may be assigned at a source time. The predefined timestamp may correspond to the source time at which the signal for each source end may be generated. In some embodiments, any deviation from the predefined timestamp may indicate potential issues. The potential issues may include network congestion, signal interference, or malicious tampering. The server 106 may effectively monitor the flow of the transmitted signals, may detect delays or disruptions in the signals transmission, and may identify the potential issues in the run-time. In some embodiments, if the received signal's timestamp may match with the predefined timestamp, the signal may be considered to have arrived on time, maintaining temporal integrity.

In some embodiments, the server 106 may be configured to determine whether the message signature associated with the signal received by each destination end is valid, upon determining the signal received by each destination end is at the predefined timestamp. Once the server 106 may determine that the signal received by each destination end may match the predefined timestamp, the server 106 may proceed to validate the message signature associated with the signal received by each destination end. The server 106 may be configured to validate the message signature associated with the signal received by each destination end to validate integrity of the signal. The server 106 may validate the signal to check for any signs of corruption, tampering, or inconsistencies in the received signal, upon receiving the signal at the predefined timestamp.

The server 106 may extract the message signature from the received signal, upon validating the predefined timestamp. The server 106 may use a predefined cryptographic key to decrypt the message signature. The decryption process may allow the server 106 to verify that the message signature may match the signal's content and each source end's identity. The server 106 may further compare the decrypted message signature with a newly computed signature based at least on the received signal's data. If the decrypted message signature and the newly computed signature may match, the server 106 may confirm that the signal may not be altered during transmission. The successful validation of the message signature may confirm the integrity of the signal and may also authenticate each source end.

In some embodiments, the server 106 may be configured to determine whether an error count of one or more errors may exceed a predefined threshold value upon determining the message signature associated with the signal received by each destination end may not be valid or upon determining the signal received by each destination end is not at the predefined timestamp. The predefined threshold value may correspond to a maximum number of errors allowable within the avionics network 104. The predefined threshold may correspond to the maximum number of errors allowable within a given period or operational context. The predefined threshold may be set based at least on criticality of the operations of the avionics network i.e., avionics system 104. If the signal received by each destination end may not arrive at the predefined timestamp or if the message signature may not be valid, then the server 106 may record the occurrences as one or more errors.

The server 106 may be configured to maintain a count of the one or more errors. Each of the one or more errors may be logged and tracked in real-time, allowing the system 100 to continuously monitor the integrity and security of the avionics network 104. The system 100 may use the predefined threshold value to determine severity of the one or more errors. In some embodiments, each time a validation fails, one or more errors may be recorded. The server 106 may maintain an ongoing count of the one or more errors. The count may be updated in real-time. Further, the server 106 may continuously compare the count of the one or more errors to the predefined threshold value. The comparison may determine whether the system 100 may be operating within acceptable limits or if there may be a need for immediate intervention. In some embodiments, if the count of the one or more errors may exceed the predefined threshold value, it may indicate a significant issue that may compromise safety and reliability of the avionics network 104.

In some embodiments, the server 106 may be configured to log one or more entries associated with the one or more errors and increment the error count, upon determining the error count of the one or more errors may not exceed the predefined threshold value. In some embodiments, the server 106 may continuously monitor the received signals. Upon detecting an anomaly, the server 106 may recognize the anomaly as one or more errors. The anomaly may correspond to the signal arriving at an incorrect time or having an invalid message signature. For each of the one or more errors, the server 106 may log one or more entries associated with the one or more errors. The one or more entries may correspond to detailed information about the one or more errors. The one or more entries may comprise, but is not limited to, error count, types of error, time of error, target audience, and recommendation.

In some embodiments, each time the one or more errors may be logged, the server 106 may increment the error count by one. The continuous tally of the error count may track frequency and severity of the one or more errors occurring within the avionics network i.e., avionics system 104. The server 106 may constantly compare the error count to the predefined threshold value. In some embodiments, if the error count may remain below the predefined threshold value, the system 100 may continue to log the one or more entries associated with the one or more errors and increment the error count without triggering an alert.

In some embodiments, the server 106 may determine whether the signal may be hampered or not. The hampered signal may indicate a Denial-of-Service (DoS) attack, or the signal tampering. The server 106 may further assess whether the received signal may be compromised in any way. The DoS attack may be identified by a sudden surge in signal traffic aimed at overwhelming the system 100. In some embodiments, if the signal may fail to arrive at each destination end within the predefined timestamp, then it may indicate an anomaly in the avionics network 104. The anomaly may signal a potential issue that may need attention. In some embodiments, the signal tampering may be detected through the anomalies in the avionics network 104 traffic. The signal tampering may be unexpected alterations in the signal. The server 106 may identify potential security threats and operational issues, by analyzing the signal.

In some embodiments, the server 106 may be configured to generate the alert associated with the one or more errors upon determining the error count of the one or more errors may exceed the predefined threshold value, for the user. Upon exceeding the predefined threshold value, the server 106 may initiate the alert generation process. The server 106 may generate the alert that may encapsulate details of the one or more errors. The generated alert may comprise the frequency of the one or more errors, the one or more components affected by the one or more errors.

Further, the server 106 may be configured to transmit the alert associated with the one or more errors to the user. Once the alert may be generated, the server 106 may transmit the generated alert to the user. The transmission of the generated alert may ensure that the generated alert may reach the user in a timely manner, allowing for immediate action. The user may correspond to the pilot or the ground support unit. The pilot may receive the alert on a cockpit display, enabling the pilot to take immediate in-flight actions if necessary. The ground support unit may receive the alert, allowing the ground support unit to prepare for maintenance and inspection upon the aircraft's landing.

Further, the alert may comprise one or more instructions such as follow standard operating procedure (SOP) and initiate inspection. The one or more instructions may guide the user on the appropriate course of action. The one or more instructions may align with the standard operating procedure and may ensure a structured response to the one or more errors. In some embodiments, the alert may instruct the user to follow established SOP. The SOP may be predefined protocols for handling different types of anomalies and security breaches. The SOP may provide a step-by-step guide to ensure that the response may be thorough and effective. In some embodiments, the alert may also instruct the user to initiate an inspection of the affected system. The inspection may involve a detailed examination to identify the root cause of the one or more errors and implement necessary repairs or adjustments.

In some embodiments, the server 106 may be configured to generate another signal for each source end having one or more parameters, upon determining the message signature associated with the signal received by each destination end is valid. Once the server 106 may validate the message signature of the received signal and confirmed the authenticity and integrity of the signal, the server 106 may initiate the generation of another signal from each source end. The subsequent signal generation may be essential for continuous monitoring and maintaining the reliability of the avionics network 104.

In some embodiments, the server 106 may be configured to determine the predefined timestamp for the signal transmission using the Artificial Intelligence (AI)/Machine Learning (ML) techniques. In one example embodiment, the one or more AI/ML techniques may correspond to natural language processing (NLP), clustering or unsupervised learning, reinforcement learning (RL) or any other AI/ML techniques known in the art. For instance, the NLP may enable the server 106 to generate the signal corresponding to the avionics network 104 for each source end with the predefined timestamp. Additionally, clustering or unsupervised learning may be employed to determine whether the signal received by each destination end may be at the predefined timestamp Furthermore, the RL technique may be utilized to dynamically optimize the structuring of the generated signal to optimize the server 106 performance over time. The one or more AI/ML techniques may enable the server 106 to autonomously learn, adapt, and improve the detection process, to provide actionable insights and support proactive maintenance efforts.

In some embodiments, the server 106 may further be configured to generate the alert associated with the one or more errors upon determining the error count of the one or more errors exceeds the predefined threshold value, for the user, using the user device 108. The user device 108 comprises a graphical user interface (GUI) that provides a user-friendly platform for the user to interact with the system 100. The GUI may be web-based, accessed through a browser, or through a dedicated software application installed on desktop computers, laptops, tablets, or smartphone. The user device 108 may be equipped by a user or other service professionals responsible for notifying the user the presence of the anomaly in the avionics network 104 of the aircraft. In some embodiments, the detection of the security breach in the avionics network 104 via the server 106 may provide a summarized data to the user that is easy to detect the security breach in the avionics network 104. In some embodiments, the user device 108 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

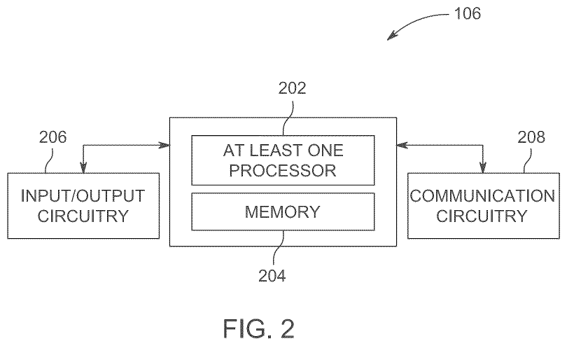

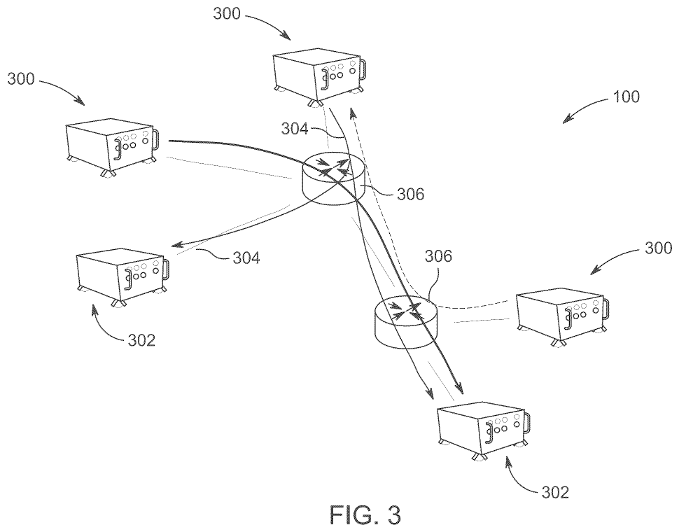

FIG. 2 illustrates a block diagram of the server 106, in accordance with an example embodiment of the present disclosure. The server 106 may comprise at least one processor 202 and a memory 204. FIG. 3 illustrates transmission of a signal from each source end 300 to each destination end 302 via one or more virtual links 304, in accordance with an example embodiment of the present disclosure. FIGS. 2-3 are described in conjunction with FIG. 1.

In some embodiments, the at least one processor 202 may correspond to a controller for executing one or more operations within the server 106. In some embodiments, the at least one processor 202 may be configured to generate the signal corresponding to the avionics network 104 for each source end with the predefined timestamp. The signal may be generated for continuous monitoring and validation of the avionics network's 104 health and operational status. Further, each generated signal may be assigned the predefined timestamp to ensure precise tracking and synchronization of the avionics network 104. The predefined timestamp may record exact source time when the signal may be generated. Further, the predefined timestamp may serve as a temporal reference that may be crucial for maintaining synchronization across the avionics network 104.

In some embodiments, each source end 300 may comprise the Flight Management System (FMS), the Automatic Flight Control System (AFCS), the navigation system, the communication system, the display system, the weather radar system, the Traffic Collision Avoidance System (TCAS), the Engine Indicating and Crew Alerting System (EICAS), the Passenger Address and Cabin Intercommunication System, the fuel management system, and the Landing Gear and Brake Control System. In some embodiments, the signal corresponding to the avionics network 104 may be generated at run-time. The signal may correspond to the health signal of the avionics network 104 and having the one or more parameters. The one or more parameters may comprise at least one of the virtual link identifier (ID), the signal ID, and the message signature.

In some embodiments, the virtual link ID may trace the path of the signal. The signal ID may uniquely identify the signal corresponding to the avionics network 104 for each source end. The signal ID may be a unique identifier for the signal itself. The signal ID may distinguish each of the signal from other signal, even if the signal may be transmitted over the same one or more virtual links 304. The signal ID may be used for accurate monitoring and validation of the avionics network 104. Further, the signal ID may aid the system 100 to track and verify each signal of the avionics network 104.

In some embodiments, the message signature may be a cryptographic feature that may ensure authenticity and integrity of the signal. The message signature may be generated using a secure cryptographic algorithm. The message signature may be generated using the Public Key Infrastructure (PKI) mechanism. The PKI mechanism may use asymmetric encryption methods to ensure that the signal may remain private and also to authenticate each source end sending the signal. The asymmetric encryption methods may involve the use of a public key and a private key.

Further, the at least one processor 202 may be configured to transmit the signal via the one or more virtual links 304, from each source end 300 to each destination end 302 with the predefined timestamp. In some embodiments, the one or more virtual links 304 corresponds to Ethernet data link. The signal may be transmitted from each source end 300 to each destination end 302 via the one or more virtual links 304 upon generating the signal with the predefined timestamp. In some embodiments, the at least one processor 202 may select the appropriate one or more virtual links 304 for the signal based at least on communication requirements. Each of the one or more virtual links 304 may be a unique pathway that may connect each source end 300 to each destination end 302. Further, the signal, accompanied by the predefined timestamp, may be transmitted through the selected one or more virtual links 304. The one or more virtual links 304 may ensure that the signal may follow a specific, pre-established route within the avionics network 104. Selection of the one or more virtual links 304 may minimize risk of the signal collision or interference.

In some embodiments, the one or more virtual links 304 may provide a high-speed communication pathway within the avionics network 104. The one or more virtual links 304 may enable the rapid transmission of the signal from each source end 300 to each destination end 302 with the predefined timestamp via the one or more virtual links 304, ensuring timely and efficient communication necessary for the real-time operations of the aircraft. Further, a switch 306 may be an integral component that may manage data traffic within the avionics network 104 between each source end 300 and each destination end 302. The switch 306 may direct the signal from each source end 300 to each destination end 302.

In some embodiments, each source end 300 and each destination end 302 may correspond to the Flight Management System (FMS), the Automatic Flight Control System (AFCS), the navigation system, the communication system, the display system, the weather radar system, the Traffic Collision Avoidance System (TCAS), the Engine Indicating and Crew Alerting System (EICAS), the Passenger Address and Cabin Intercommunication System, the fuel management system, and the Landing Gear and Brake Control System.

In some embodiments, the at least one processor 202 may be configured to determine whether the signal received by each destination end 302 is at the predefined timestamp. The at least one processor 202 may determine whether the received signal's timestamp may match the predefined timestamp. The at least one processor 202 may compare the received signal's timestamp with the predefined timestamp that may be assigned at a source time. The predefined timestamp may correspond to the source time at which the signal for each source end may be generated. In some embodiments, any deviation from the predefined timestamp may indicate potential issues. The potential issues may include network congestion, signal interference, or malicious tampering. The at least one processor 202 may effectively monitor the flow of the transmitted signals, may detect delays or disruptions in the signals transmission, and may identify the potential issues in the run-time. In some embodiments, if the received signal's timestamp may match with the predefined timestamp, the signal may be considered to have arrived on time, maintaining temporal integrity.

In some embodiments, the at least one processor 202 may be configured to determine whether the message signature associated with the signal received by each destination end 302 is valid, upon determining the signal received by each destination end 302 is at the predefined timestamp. Once the at least one processor 202 may determine that the signal received by each destination end 302 matches the predefined timestamp, the at least one processor 202 may proceed to validate the message signature associated with the signal received by each destination end 302. The at least one processor 202 may be configured to validate the message signature associated with the signal received by each destination end 302 to validate integrity of the signal. The at least one processor 202 may validate the signal to check for any signs of corruption, tampering, or inconsistencies in the received signal, upon receiving the signal at the predefined timestamp.

In some embodiments, the at least one processor 202 may be configured to determine whether an error count of one or more errors may exceed a predefined threshold value upon determining the message signature associated with the signal received by each destination end 302 may not be valid or upon determining the signal received by each destination end 302 is not at the predefined timestamp. The predefined threshold value may correspond to a maximum number of errors allowable within the avionics network 104. The predefined threshold may correspond to the maximum number of errors allowable within a given period or operational context. The predefined threshold may be set based at least on criticality of the operations of the avionics systems 104. If the signal received by each destination end 302 may not arrive at the predefined timestamp or if the message signature may not be valid, then the at least one processor 202 may record the occurrences as one or more errors.

The at least one processor 202 may be configured to maintain a count of the one or more errors. Each of the one or more errors may be logged and tracked in real-time, allowing the system 100 to continuously monitor the integrity and security of the avionics network 104. The system 100 may use the predefined threshold value to determine severity of the one or more errors. In some embodiments, each time a validation fails, one or more errors may be recorded. The at least one processor 202 may maintain an ongoing count of the one or more errors. The count may be updated in real-time. Further, the at least one processor 202 may continuously compare the count of the one or more errors to the predefined threshold value. The comparison may determine whether the system 100 may be operating within acceptable limits or if there may be a need for immediate intervention. In some embodiments, if the count of the one or more errors may exceed the predefined threshold value, it may indicate a significant issue that may compromise safety and reliability of the avionics network 104.

In some embodiments, the at least one processor 202 may be configured to log one or more entries associated with the one or more errors and incrementing the error count, upon determining the error count of the one or more errors may not exceed the predefined threshold value. In some embodiments, the at least one processor 202 may continuously monitor the received signals. Upon detecting an anomaly, the at least one processor 202 may recognize the anomaly as one or more errors. The anomaly may correspond to the signal arriving at an incorrect time or having an invalid message signature. For each of the one or more errors, the at least one processor 202 may log one or more entries associated with the one or more errors. The one or more entries may correspond to detailed information about the one or more errors. The one or more entries may comprise, but is not limited to, error count, types of error, time of error, target audience, and recommendation.

In some embodiments, each time the one or more errors may be logged, the at least one processor 202 may increment the error count by one. The continuous tally of the error count may track frequency and severity of the one or more errors occurring within the avionics system 104. The at least one processor 202 may constantly compare the error count to the predefined threshold value. In some embodiments, if the error count may remain below the predefined threshold value, the system 100 may continue to log the one or more entries associated with the one or more errors and increment the error count without triggering an alert.

In some embodiments, the at least one processor 202 may be configured to generate the alert associated with the one or more errors upon determining the error count of the one or more errors may exceed the predefined threshold value, for the user. Upon exceeding the predefined threshold value, the at least one processor 202 may initiate the alert generation process. The at least one processor 202 may generate the alert that encapsulates details of the one or more errors. The generated alert may comprise the frequency of the one or more errors, the one or more components affected by the one or more errors.

Further, the at least one processor 202 may be configured to transmit the alert associated with the one or more errors to the user. Once the alert may be generated, the at least one processor 202 may transmit the generated alert to the user. The transmission of the generated alert may ensure that the generated alert may reach the user in a timely manner, allowing for immediate action. The user may correspond to the pilot or the ground support unit. The pilot may receive the alert on a cockpit display, enabling the pilot to take immediate in-flight actions if necessary. The ground support unit may receive the alert, allowing the ground support unit to prepare for maintenance and inspection upon the aircraft's landing.

Further, the alert may comprise one or more instructions such as follow standard operating procedure (SOP) and initiate inspection. The one or more instructions may guide the user on the appropriate course of action. The one or more instructions may align with the standard operating procedure and may ensure a structured response to the one or more errors. In some embodiments, the alert may instruct the user to follow established a standard operating procedure (SOP). The SOP may be predefined protocols for handling different types of anomalies and security breaches. The SOP may provide a step-by-step guide to ensure that the response may be thorough and effective. In some embodiments, the alert may also instruct the user to initiate an inspection of the affected system. The inspection may involve a detailed examination to identify the root cause of the one or more errors and implement necessary repairs or adjustments.

In some embodiments, the at least one processor 202 may be configured to generate another signal for each source end 300 having one or more parameters, upon determining the message signature associated to the signal received by each destination end 302 is valid. Once the at least one processor 202 may validate the message signature of the received signal and confirmed the authenticity and integrity of the signal, the at least one processor 202 may initiate the generation of another signal from each source end 300. The subsequent signal generation may be essential for continuous monitoring and maintaining the reliability of the avionics network 104.

In some embodiments, the at least one processor 202 may be configured to identify each source end 300 and each destination end 302 within the avionics network 104 with one or more deterministic traffic capabilities. The one or more deterministic traffic capabilities may refer to the ability of the avionics network 104 to handle the signal transmission in a highly predictable manner. The at least one processor 202 may be configured to identify each source end 300 within the avionics network 104. Each source end 300 may be the origin point of the signals. Identification of each source end 300 may involve recognizing the one or more parameters associated with each source end. Similarly, the at least one processor 202 may identify each destination end 302 within the avionics network 104. Each destination end 302 may be the point where the signal may be intended to be received. Identification of each destination end 302 may include acknowledging the one or more parameters tied to each destination end 302. The one or more parameters may comprise at least one of the virtual link identifier (ID), the signal ID, and the message signature.

Further, the at least one processor 202 may be configured to identify the communication scheme, at least one type for each source end 300 and each destination end 302, and the critical traffic virtual links for each source end and each destination. In some embodiments, the at least one processor 202 may be configured to identify the communication scheme utilized by each source end and each destination end 302. The communication scheme may refer to the set of protocols, rules, and structures that govern the transmission of the signals within the avionics network 104. Within the communication scheme, there may be various types of communication, each serving different purposes and adhering to different protocols.

In some embodiments, the at least one processor 202 may identify the critical traffic virtual links for each source end 300 and each destination end 302. The virtual links may be logical connection within the avionics network 104 that may define the path the signal may take from each source end 300 to each destination end 302. In some embodiments, not all the virtual links are equal, some virtual links may carry more critical signal than others. The at least one processor 202 may identify which virtual links may be designated for critical traffic. The critical data may correspond to the data that may be vital for safe and efficient operation of the aircraft.

In some embodiments, by identifying the communication scheme for each source end 300 and each destination end 302, along with the critical traffic virtual links, the at least one processor 202 may ensure that the communication may occur at the predefined timestamp and may follow predetermined pathways.

Further, the at least one processor 202 may be configured to add at least one slot in each source end to transmit the signal with the predefined timestamp and at least one slot in each destination end 302 to receive the signal at the predefined timestamp. The at least one slot in each source end 300 and the at least one slot in each destination end 302 may correspond to the specific time interval, the logical channel, or the frequency range during which the signal may be configured to be transmitted from each source end 300 to each destination end 302. Each source end 300 and each destination end 302 in the avionics network 104 may correspond to the one or more origins and the one or more target points of data communication or the signal transmission within the avionics network 104, respectively.

In some embodiments, the at least one processor 202 may be configured the to add at least one slot in each source end 300. The at least one slot may correspond to the predefined time interval, the logical channel, or the frequency range allocated specifically for transmitting the signal with the predefined timestamp. The at least one slot may ensure that each source end 300 may transmit the signal in a synchronized and orderly manner, reducing the risk of data collision or interference. Further, the at least one processor 202 may add the at least one slot in each destination end 302. The at least one slot may correspond to the predefined time interval, the logical channel, or the frequency range during which each destination end 302 may be configured to receive the signal. The at least one slot may ensure that each destination end 302 may be ready to process the incoming signal at the predefined timestamp, maintaining temporal integrity of the communication. In some embodiments, the at least one processor 202 may be configured to determine the predefined timestamp for the signal transmission using the Artificial Intelligence (AI)/Machine Learning (ML) techniques.

In one example embodiment, the one or more AI/ML techniques may correspond to natural language processing (NLP), clustering or unsupervised learning, reinforcement learning (RL) or any other AI/ML techniques known in the art. For instance, the NLP may enable the system 100 to generate the signal corresponding to the avionics network 104 for each source end 300 with the predefined timestamp. Additionally, clustering or unsupervised learning may be employed to determine whether the signal received by each destination end 302 may be at the predefined timestamp. Furthermore, the RL technique may be utilized to dynamically optimize the structuring of the generated signal to optimize the performance over time. The one or more AI/ML techniques may enable the system 100 to autonomously learn, adapt, and improve the detection process, to provide actionable insights and support proactive maintenance efforts.

The at least one processor 202 may include suitable logic, circuitry, and/or interfaces that are operable to execute one or more instructions stored in the memory 204 to perform predetermined operations. In some embodiments, the at least one processor 202 may be configured to generate and store the signal, the message signature, the predefined timestamp, and the alert in the memory 204 communicatively coupled to the at least one processor 202. In one embodiment, the at least one processor 202 may be configured to decode and execute any instructions received from one or more other electronic devices or server(s). The at least one processor 202 may be configured to execute one or more computer-readable program instructions, such as program instructions to carry out any of the functions described in this description. Further, the processor may be implemented using the at least one processor 202 technologies known in the art. Examples of the at least one processor 202 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 204 may be configured to store a set of instructions and data executed by the at least one processor 202. Further, the memory 204 may include the one or more instructions that are executable by the at least one processor 202 to perform specific operations. The memory 204 may be configured to include the instructions to generate the signal corresponding to the avionics network 104 for each source end 300 with the predefined timestamp The memory 204 may be configured to include the instructions to transmit the signal from each source end 300 to each destination end 302 with the predefined timestamp via the one or more virtual links. The memory 204 may be configured to include the instructions to determine whether the error count of the one or more errors may exceed the predefined threshold value upon determining the message signature associated to the signal received by each destination end 302 may not be valid or upon determining the signal received by each destination end 302 may not be at the predefined timestamp. Further, the memory 204 may be configured to include the instructions to generate the alert associated with the one or more errors upon determining the error count of the one or more errors may exceed the predefined threshold value, for the user.

The memory 204 may be configured to include the instructions to determine whether the message signature associated to the signal received by each destination end 302 may be valid, upon determining the signal received by each destination end 302 may be at the predefined timestamp. It is apparent to a person with ordinary skill in the art that the one or more instructions stored in the memory 204 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 106 may further comprise an input/output circuitry 206. The input/output circuitry 206 may enable the user to communicate or interface with the system 100, via the user device 108. The user device 108 may include N number of user devices. In some embodiments, the input/output circuitry 206 may act as a medium to transmit input from the interface to and from the system 100. In some embodiments, the input/output circuitry 206 may refer to the hardware and software components that facilitate the exchange of information between the user device and the server 106. In one example, the server 106 may include a graphical user interface (GUI) (not shown) as input circuitry to allow the users to input data. The input/output circuitry 206 may include various input devices such as keyboards, barcode scanners, GUI for the users to provide data and various output devices such as displays, printers for the one or more users to receive data. In another example, the input/output circuitry 206 may include various output circuitry such as a display. In one example, the input/output circuitry 206 may interface with the avionics network 104. The input/output circuitry 206 may further display relevant information to the user on the user device 108.

In some embodiments, the server 106 may further comprise a communication circuitry 208. The communication circuitry 208 may allow the server 106 to exchange data or information with other systems or apparatuses. Further, the communication circuitry 208 may include network interfaces, protocols, and software modules responsible for sending and receiving data or information. In some embodiments, the communication circuitry 208 may include Ethernet ports, Wi-Fi adapters, or communication protocols like HTTP or MQTT for connecting with other systems. The communication circuitry 208 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 208 may allow the system 100 to stay up-to-date. In some embodiments, the communication circuitry 208 may enable seamless communication between the user device 108, and the avionics network 104. The communication circuitry 208 may further ensure the signal, and the alert may transmit securely and efficiently between the user device 108, and the avionics network 104.

It will be apparent to one skilled in the art the above-mentioned components of the server 106 have been provided only for illustration purposes, without departing from the scope of the disclosure.

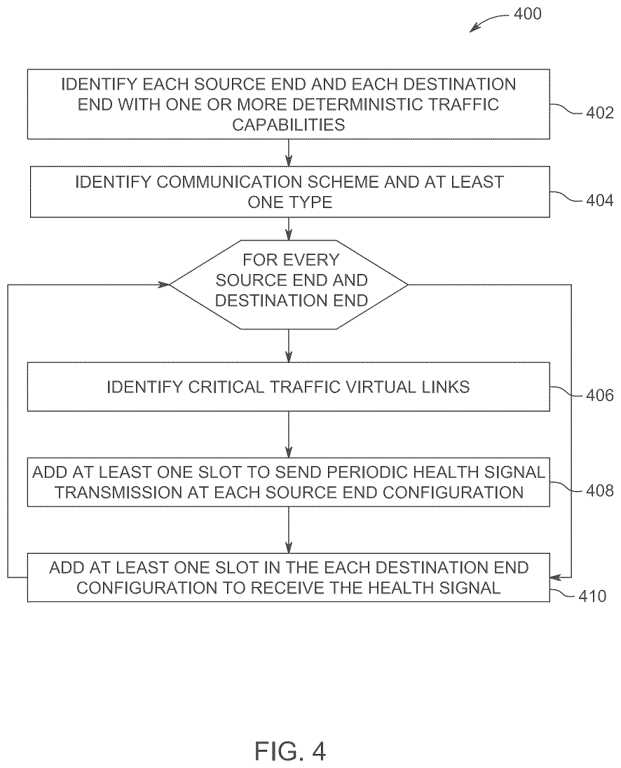

FIG. 4 illustrates a flowchart 400 showing a design time configuration of the avionics network 104, in accordance with an example embodiment of the present disclosure.

At operation 402, the at least one processor 202 may be configured to identify each source end 300 and each destination end 302 within the avionics network 104 having one or more deterministic traffic capabilities. In some embodiments, the at least one processor 202 may identify each source end 300 and each destination end 302 involved in the avionics network 104. Further, the at least one processor 202 may access each source end 300 and each destination end 302 with capability to handle deterministic traffic.

At operation 404, the at least one processor 202 may be configured to identify the communication scheme, the at least one type for each source end 300 and each destination end 302. In some embodiments, the at least one processor 202 may be configured to determine specific communication protocols and type of the communication used by each source end 300 for transmitting the signal. The specific communication protocol may comprise ARINC 429, or AFDX. Further, the type of the communication may comprise time-triggered, and rate-constrained.

At operation 406, the at least one processor 202 may be configured to identify the one or more virtual links 304 (i.e. critical traffic virtual links) that may carry the critical traffic for each source end 300 and each destination end 302 to ensure the signal may be monitored effectively. At operation 408, the at least one processor 202 may be configured to add at least one slot in each source end 300 to transmit the signal with the predefined timestamp. At operation 410, the at least one processor 202 may be configured to add at least one slot in each destination end 302 to receive the signal with the predefined timestamp. In some embodiments, the at least one slot in each source end 300 and each destination end 302 may correspond to a specific time interval, logical channel, or frequency range during which the signal is configured to be transmitted from each source end 300 to the destination end 302.

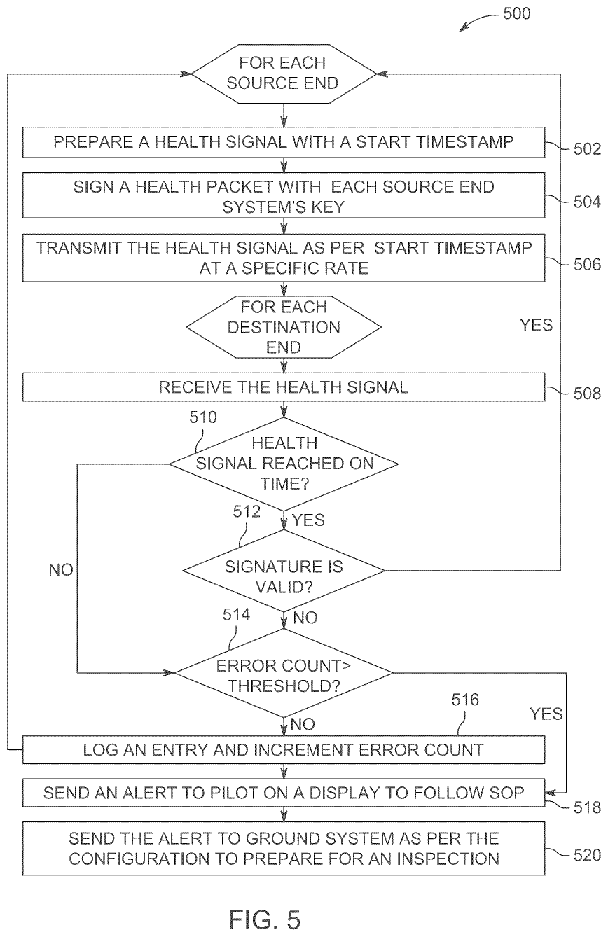

FIG. 5 illustrates a flowchart 500 showing a run-time configuration of the avionics network 104, in accordance with an example embodiment of the present disclosure. FIG. 5 is described in conjunction with FIGS. 1-4.

At operation 502, the at least one processor 202 may be configured to prepare the signal with the predefined timestamp i.e. start time stamp. Further, at operation 504, the at least one processor 202 may be configured to sign the signal with the message signature (i.e. source end system key). Further, at operation 506, the at least one processor 202 may be configured to transmit the signal with the predefined timestamp from each source end 300. Further, at operation 508, the at least one processor 202 for each destination end 302, may be configured to receive the signal. Further, at operation 510, the at least one processor 202 may be configured to determine whether the signal reached on the predefined timestamp to each destination end 302.

Further, at operation 512, the at least one processor 202 may be configured to determine whether the message signature is valid or not, upon determining the signal reached on the predefined timestamp to each destination end 302. Further, at operation 514, the at least one processor 202 may be configured to determine whether the error count may is greater than the predefined threshold value, upon determining the signal couldn't reach on the predefined timestamp to each destination end 302 or the message signature is not valid. Further, the at least one processor 202 may be configured to redirect to operation 502.

Further, at operation 516, the at least one processor 202 may be configured to log the one or more entries, and increment the error count, upon determining the error count is not greater than the predefined threshold value. Further, at operation 518, the at least one processor 202 may be configured to send the alert to the user, upon determining the error is greater than the predefined threshold value and follow the SOP. In one example, the user may correspond to the pilot. Thereafter, at operation 520, the at least one processor 202 may be configured to send the alert to the user to prepare for an inspection.

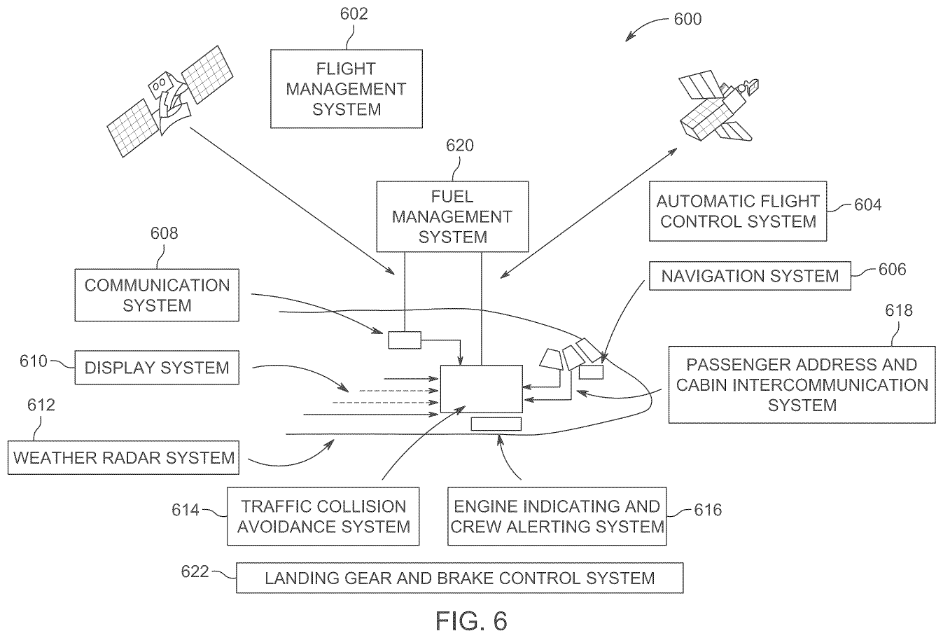

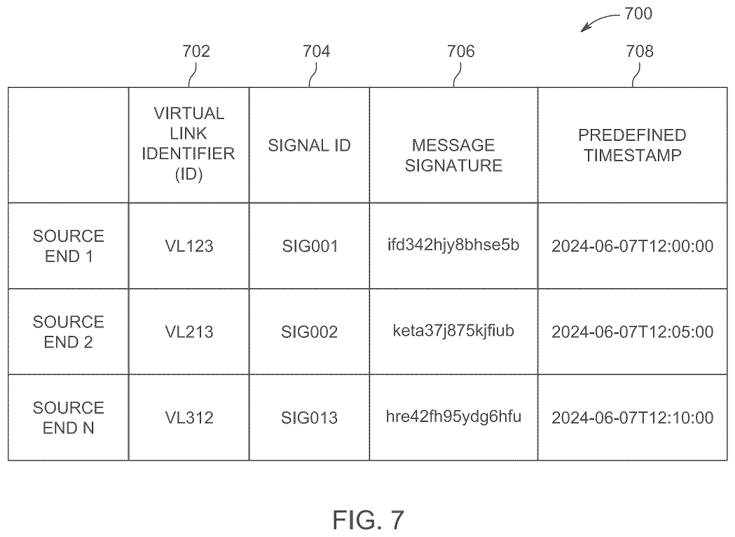

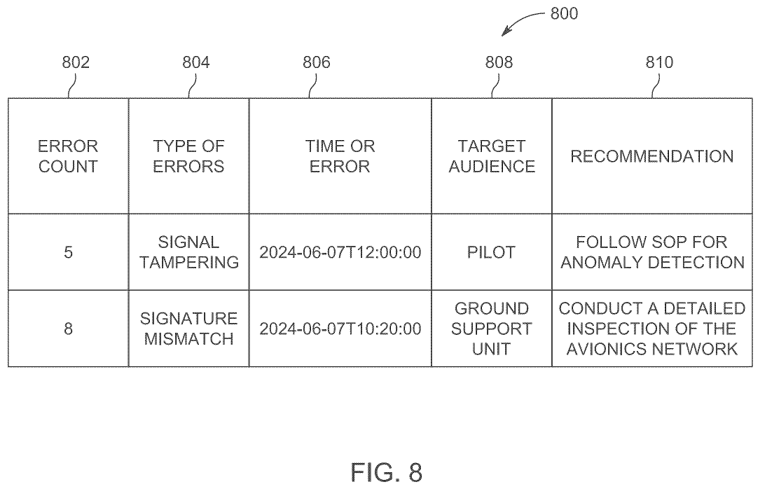

FIG. 6 illustrates one or more components of the avionics network 104 of an aircraft 600, in accordance with an example embodiment of the present disclosure. FIG. 7 illustrates a database 700 for a health signal of the avionics network 104 for the aircraft 600, in accordance with an example embodiment of the present disclosure. FIG. 8 illustrates an error database 800 within the avionics network 104 of the aircraft 600, in accordance with an example embodiment of the present disclosure. FIGS. 6-8 are described in conjunction with FIGS. 1-5.

The avionics network 104 of the aircraft 600 may comprise the one or more components. The one or more components may correspond to each source end 300 and each destination end 302. The one or more components may comprise a flight management system (FMS) 602, an automatic flight control system (AFCS) 604, a navigation system 606, a communication system 608, a display system 610, a weather radar system 612, a traffic collision avoidance system (TCAS) 614, an engine indicating and crew alerting system (EICAS) 616, a passenger address and cabin intercommunication system 618, a fuel management system 620, and a landing gear and brake control system 622.

In some embodiments, the FMS 602 may manage the aircraft planning by allowing the user to input an aircraft plan. The aircraft plan may comprise route, waypoints, and altitude data. The FMS 602 may optimize the route based at least on one or more factors. The one or more factors may comprise the aircraft performance and weather conditions. The FMS 602 may integrate with an autopilot system to guide the aircraft along the planned route. In some embodiments, the AFCS 604 may control the aircraft's path without direct intervention of the user. The AFCS 604 may maintain set course, altitude, and speed. In some embodiments, the navigation system may ensure that the aircraft may accurately determine the aircraft position and follow the planned route. The navigation system 606 may further comprise Global Positioning System (GPS) for global navigation, VHF Omnidirectional Range (VOR) for radio-based navigation, and Inertial Navigation System (INS). The navigation system 606 may use one or more sensors to track the aircraft's position.

In some embodiments, the communication system 608 may facilitate voice and data communication between the aircraft and ground stations, and between the aircraft. The communication system 608 may include, but is not limited to VHF/UHF radios for short-range communication, HF radios for long-range communication, and Satellite Communications (Satcom) for global coverage. In some embodiments, the display system 610 may display the aircraft information. The aircraft information may comprise airspeed, altitude, heading, and navigation data.

In some embodiments, the weather radar system 612 may detect weather conditions ahead of the aircraft. The weather radar system 612 may allow pilot to avoid severe weather such as thunderstorms and turbulence. The weather radar system 612 may use radar signals to map the weather patterns and may provide visual representations on the display system. In some embodiments, the TCAS 614 may prevent mid-air collisions by monitoring the airspace around the aircraft and providing collision avoidance instructions. The TCAS 614 may alert the user to the presence of other aircraft.

In some embodiments, the fuel management system 620 may monitor and manage distribution and consumption of fuel throughout the aircraft's fuel tanks. The fuel management system 620 may further ensure the optimal fuel usage and may alert the crew to any discrepancies or potential issues. In some embodiments, the landing gear and brake control system 622 may control extension and retraction of landing gear and may manage the braking system. The landing gear and brake control system 622 may ensure safe takeoff and landing operations.

In some embodiments, the at least one processor 202 may be configured to generate the signal (i.e., a health signal) from each source end 300 of the avionics network 104 within the aircraft 600, having a predefined timestamp 708 and having the one or more parameters and stored within the database 700.

The one or more parameters comprises at least one of a virtual link identifier (ID) 702, a signal ID 704, and a message signature 706. In one example, the signal may be generated from a source end 1, a source end 2, and a source end 3 installed within the aircraft 600. The source end 1 may correspond to the FMS 602, the source end 2 may correspond to weather radar system 612 and the source end 3 may correspond to the fuel management system 620.

For the source end 1, the virtual link ID 702 may correspond to VL123. Further, the signal ID 704 may correspond to SIG001. The message signature 706 may correspond to ifd342hjy8bhse5b. Further, the predefined timestamp 708 may correspond to 2024-06-07T12:00:00. In another example, for the source end 2, the virtual link ID 702 may correspond to VL213. Further, the signal ID 704 may correspond to SIG002. The message signature 706 may correspond to keta37j875kjfiub. Further, the predefined timestamp 708 may correspond to 2024-06-07T12:05:00. In yet another example, for source end N, the virtual link ID 702 may correspond to VL312. Further, the signal ID 704 may correspond to SIG013. The message signature 706 may correspond to hre42fh95ydg6hfu. Further, the predefined timestamp 708 may correspond to 2024-06-07T12:10:00.

In one example, for the source end 1, the error count 802 may correspond to 5. Further, a type of error 804 may correspond to signal tampering. Further, time of error 806 may correspond to 2024-06-07T12:00:00. Further, a target audience 808 may correspond to the Pilot. Further, a recommendation 810 may correspond to follow SOP for anomaly detection. In another example, for source end 2, the error count 802 may correspond to 8. Further, the type of error 804 may correspond to message signature mismatch. Further, a time of error 806 may correspond to 2024-06-07T10:20:00. Further, target audience 808 may correspond to the ground support unit. Further, the recommendation 810 may correspond to conduct a detailed inspection of the avionics network.

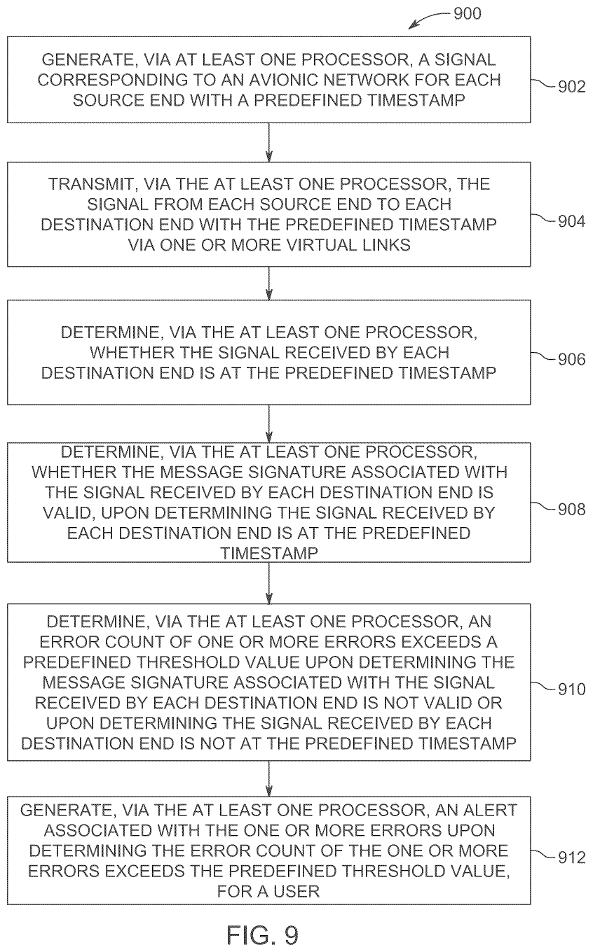

FIG. 9 illustrates a flowchart 900 showing a method for detecting security breach within the avionics network 104, in accordance with an example embodiment of the present disclosure. FIG. 9 is described in conjunction with FIGS. 1-8.

At operation 902, the at least one processor 202 may be configured to generate the signal corresponding to the avionics network 104 for each source end 300 with the predefined timestamp The signal may be generated for continuous monitoring and validation of the avionics network's 104 health and operational status. Further, each generated signal may be assigned the predefined timestamp to ensure precise tracking and synchronization of the avionics network 104. The predefined timestamp may record exact source time when the signal may be generated. Further, the predefined timestamp may serve as a temporal reference that may be crucial for maintaining synchronization across the avionics network 104.

At operation 904, the at least one processor 202 may be configured to transmit the signal from each source end 300 to each destination end 302 with the predefined timestamp via the one or more virtual links 304. The signal may be transmitted from each source end 300 to each destination end 302 via the one or more virtual links 304 upon generating the signal with the predefined timestamp. In some embodiments, the at least one processor 202 may select the appropriate one or more virtual links 304 for the signal based at least on communication requirements. Each of the one or more virtual links 304 may be a unique pathway that may connect each source end 300 to each destination end 302. Further, the signal, accompanied by the predefined timestamp, may be transmitted through the selected one or more virtual links 304. The one or more virtual links 304 may ensure that the signal may follow a specific, pre-established route within the avionics network 104. Selection of the one or more virtual links 304 may minimize risk of the signal collision or interference.

At operation 906, the at least one processor 202 may be configured to determine whether the signal received by each destination end 302 is at the predefined timestamp. The at least one processor 202 may determine whether the received signal's timestamp may match the predefined timestamp. The at least one processor 202 may compare the received signal's timestamp with the predefined timestamp that may be assigned at a source time. The predefined timestamp may correspond to the source time at which the signal for each source end 300 may be generated. In some embodiments, any deviation from the predefined timestamp may indicate potential issues. The potential issues may include network congestion, signal interference, or malicious tampering. The at least one processor 202 may effectively monitor the flow of the transmitted signals, may detect delays or disruptions in the signals transmission, and may identify the potential issues in the run-time. In some embodiments, if the received signal's timestamp may match with the predefined timestamp, the signal may be considered to have arrived on time, maintaining temporal integrity.

At operation 908, the at least one processor 202 may be configured to determine whether the message signature associated to the signal received by each destination end 302 is valid, upon determining the signal received by each destination end 302 is at the predefined timestamp. Once the at least one processor 202 may determine that the signal received by each destination end 302 may match the predefined timestamp, the at least one processor 202 may proceed to validate the message signature associated with the signal received by each destination end 302. The at least one processor 202 may be configured to validate the message signature associated to the signal received by each destination end 302 to validate integrity of the signal. The at least one processor 202 may validate the signal to check for any signs of corruption, tampering, or inconsistencies in the received signal, upon receiving the signal at the predefined timestamp.

At operation 910, the at least one processor 202 may be configured to determine whether an error count of one or more errors may exceed a predefined threshold value upon determining the message signature associated to the signal received by each destination end 302 may not be valid or upon determining the signal received by each destination end 302 is not at the predefined timestamp. The predefined threshold value may correspond to a maximum number of errors allowable within the avionics network 104. The predefined threshold may correspond to the maximum number of errors allowable within a given period or operational context. The predefined threshold may be set based at least on criticality of the operation of the avionics network i.e., avionics system 104. If the signal received by each destination end 302 may not arrive at the predefined timestamp or if the message signature may not be valid, then the at least one processor 202 may record the occurrences as one or more errors.

At operation 912, the at least one processor 202 may be configured to generate the alert associated with the one or more errors upon determining the error count of the one or more errors may exceed the predefined threshold value, for the user. Upon exceeding the predefined threshold value, the at least one processor 202 may initiate the alert generation process. The at least one processor 202 may generate the alert that may encapsulate details of the one or more errors. The generated alert may comprise the frequency of the one or more errors, the one or more components affected by the one or more errors.

In some embodiments, a non-transitory machine-readable information storage medium is disclosed. The non-transitory machine-readable information storage medium may comprise one or more instructions which when executed by at least one processor 202 cause the at least one processor 202 to generate a signal corresponding to the avionics network 104 for each source end 300 with a predefined timestamp. The signal corresponds to a health signal of the avionics network 104 and having one or more parameters. The one or more parameters comprises at least one of a virtual link identifier (ID), a signal ID, and a message signature. Further, the non-transitory machine-readable information storage medium may comprise one or more instructions which when executed by the at least one processor 202 cause the at least one processor 202 to transmit the signal from each source end 300 to each destination end 302 with the predefined timestamp via one or more virtual links.

Further, the non-transitory machine-readable information storage medium may comprise one or more instructions which when executed by the at least one processor 202 cause the at least one processor 202 to determine whether the signal received by each destination end 302 is at the predefined timestamp. The predefined timestamp corresponds to a source time at which the signal for each source end 300 is generated. Further, the non-transitory machine-readable information storage medium may comprise one or more instructions which when executed by the at least one processor 202 cause the at least one processor 202 to determine whether the message signature associated to the signal received by each destination end 302 is valid, upon determining the signal received by each destination end 302 is at the predefined timestamp.

Further, the non-transitory machine-readable information storage medium may comprise one or more instructions which when executed by the at least one processor 202 cause the at least one processor 202 to determine whether an error count of one or more errors exceeds a predefined threshold value upon determining the message signature associated to the signal received by each destination end 302 is not valid or upon determining the signal received by each destination end 302 is not at the predefined timestamp. The predefined threshold value corresponds to a maximum number of errors allowable within the avionics network 104. Further, the non-transitory machine-readable information storage medium may comprise one or more instructions which when executed by the at least one processor 202 cause the at least one processor 202 to generate an alert associated with the one or more errors upon determining the error count of the one or more errors exceeds the predefined threshold value.

Further, the non-transitory machine-readable information storage medium may comprise one or more instructions which when executed by the at least one processor 202 cause the at least one processor 202 to generate another signal for each source end 300 having one or more parameters, upon determining the message signature associated to the signal received by each destination end 302 is valid. Further, the non-transitory machine-readable information storage medium may comprise one or more instructions which when executed by the at least one processor 202 cause the at least one processor 202 to log one or more entries associated with the one or more errors and increment the error count, upon determining the error count of the one or more errors does not exceeds the predefined threshold value.

Further, the non-transitory machine-readable information storage medium may comprise one or more instructions which when executed by the at least one processor 202 cause the at least one processor 202 to transmit the alert associated with the one or more errors to the user. The user corresponds to a pilot or a ground support unit. The alert comprises one or more instructions such as follow standard operating procedure (SOP) and initiate inspection. Further, the non-transitory machine-readable information storage medium may comprise one or more instructions which when executed by the at least one processor 202 cause the at least one processor 202 to identify each source end 300 and each destination end 302 within the avionics network with one or more deterministic traffic capabilities.

Further, the non-transitory machine-readable information storage medium may comprise one or more instructions which when executed by the at least one processor 202 cause the at least one processor 202 to identify a communication scheme, at least one type for each source end 300 and each destination end 302, and a critical traffic virtual links for each source end 300 and each destination. Thereafter, the non-transitory machine-readable information storage medium may comprise one or more instructions which when executed by the at least one processor 202 cause the at least one processor 202 to add at least one slot in each source end 300 to transmit the signal with the predefined timestamp and at least one slot in each destination end 302 to receive the signal at the predefined timestamp. The at least one slot in each source end 300 and the at least one slot in each destination end 302 correspond to a specific time interval, logical channel, or frequency range during which the signal is configured to be transmitted from each source end 300 to each destination end 302.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
generating, via at least one processor, a signal corresponding to avionics network for each source end with a predefined timestamp, wherein the signal corresponds to a health signal of the avionics network and having one or more parameters, wherein the one or more parameters comprise at least one of a virtual link identifier (ID), a signal ID, and a message signature;
transmitting, via the at least one processor, the signal from each source end to each destination end with the predefined timestamp via one or more virtual links;
determining, via the at least one processor, whether the signal received by each destination end is at the predefined timestamp, wherein the predefined timestamp corresponds to a source time at which the signal for each source end is generated;
determining, via the at least one processor, whether the message signature associated with the signal received by each destination end is valid, upon determining the signal received by each destination end is at the predefined timestamp;
determining, via the at least one processor, whether an error count of one or more errors exceeds a predefined threshold value upon determining the message signature associated with the signal received by each destination end is not valid or upon determining the signal received by each destination end is not at the predefined timestamp, wherein the predefined threshold value corresponds to a maximum number of errors allowable within the avionics network; and
generating, via the at least one processor, an alert associated with the one or more errors upon determining the error count of the one or more errors exceeds the predefined threshold value, for a user.

2. The method of claim 1 further comprising generating, via the at least one processor, another signal for each source end having one or more parameters, upon determining the message signature associated with the signal received by each destination end is valid.

3. The method of claim 1, further comprising logging, via the at least one processor, one or more entries associated with the one or more errors and incrementing the error count, upon determining the error count of the one or more errors does not exceeds the predefined threshold value.

4. The method of claim 1 further comprising transmitting, via the at least one processor, the alert associated with the one or more errors to the user, wherein the user corresponds to a pilot or a ground support unit.

5. The method of claim 1, wherein the alert comprises one or more instructions such as follow standard operating procedure (SOP) and initiate inspection.

6. The method of claim 1, further comprising:
identifying, via the at least one processor, each source end and each destination end within the avionics network with one or more deterministic traffic capabilities;
identifying, via the at least one processor, a communication scheme, at least one type for each source end and each destination end, and a critical traffic virtual links for each source end and each destination end; and
adding, via the at least one processor, at least one slot in each source end to transmit the signal with the predefined timestamp and at least one slot in each destination end to receive the signal at the predefined timestamp.

7. The method of claim 6, wherein the at least one slot in each source end and the at least one slot in each destination end correspond to a specific time interval, logical channel, or frequency range during which the signal is configured to be transmitted from each source end to each destination end.

8. The method of claim 1, wherein each source end and each destination end in the avionics network correspond to one or more origins and one or more target points of data communication or signal transmission within the avionics network, respectively.

9. A system comprising:
a memory; and
at least one processor communicatively coupled to the memory, wherein the at least one processor is configured to:
generate a signal corresponding to avionics network for each source end with a predefined timestamp, wherein the signal corresponds to a health signal of the avionics network and having one or more parameters, wherein the one or more parameters comprise at least one of a virtual link identifier (ID), a signal ID, and a message signature;
transmit the signal from each source end to each destination end with the predefined timestamp via one or more virtual links;
determine whether the signal received by each destination end is at the predefined timestamp, wherein the predefined timestamp corresponds to a source time at which the signal for each source end is generated;
determine whether the message signature associated with the signal received by each destination end is valid, upon determining the signal received by each destination end is at the predefined timestamp;
determine whether an error count of one or more errors exceeds a predefined threshold value upon determining the message signature associated with the signal received by each destination end is not valid or upon determining the signal received by each destination end is not at the predefined timestamp, wherein the predefined threshold value corresponds to a maximum number of errors allowable within the avionics network; and
generate an alert associated with the one or more errors upon determining the error count of the one or more errors exceeds the predefined threshold value, for a user.

10. The system of claim 9, wherein the at least one processor is further configured to generate another signal for each source end having one or more parameters, upon determining the message signature associated with the signal received by each destination end is valid.

11. The system of claim 9, wherein the at least one processor is further configured to log one or more entries associated with the one or more errors and increment the error count, upon determining the error count of the one or more errors does not exceeds the predefined threshold value.

12. The system of claim 9, wherein the at least one processor is further configured to transmit the alert associated with the one or more errors to the user, wherein the user corresponds to a pilot or a ground support unit.

13. The system of claim 9, wherein the alert comprises one or more instructions such as follow standard operating procedure (SOP) and initiate inspection.

14. The system of claim 9, wherein the at least one processor is further configured to:
identify each source end and each destination end within the avionics network with one or more deterministic traffic capabilities;
identify a communication scheme, at least one type for each source end and each destination end, and a critical traffic virtual links for each source end and each destination end; and
add at least one slot in each source end to transmit the signal with the predefined timestamp and at least one slot in each destination end to receive the signal at the predefined timestamp.

15. The system of claim 14, wherein the at least one slot in each source end and the at least one slot in each destination end correspond to a specific time interval, logical channel, or frequency range during which the signal is configured to be transmitted from each source end to each destination end.

16. The system of claim 9, wherein each source end and each destination end in the avionics network correspond to one or more origins and one or more target points of data communication or signal transmission within the avionics network, respectively.

17. A non-transitory machine-readable information storage medium comprising one or more instructions which when executed by at least one processor cause the at least one processor to:
generate a signal corresponding to avionics network for each source end with a predefined timestamp, wherein the signal corresponds to a health signal of the avionics network and having one or more parameters, wherein the one or more parameters comprise at least one of a virtual link identifier (ID), a signal ID, and a message signature;
transmit the signal from each source end to each destination end with the predefined timestamp via one or more virtual links;
determine whether the signal received by each destination end is at the predefined timestamp, wherein the predefined timestamp corresponds to a source time at which the signal for each source end is generated;
determine whether the message signature associated with the signal received by each destination end is valid, upon determining the signal received by each destination end is at the predefined timestamp;
determine whether an error count of one or more errors exceeds a predefined threshold value upon determining the message signature associated with the signal received by each destination end is not valid or upon determining the signal received by each destination end is not at the predefined timestamp, wherein the predefined threshold value corresponds to a maximum number of errors allowable within the avionics network; and
generate an alert associated with the one or more errors upon determining the error count of the one or more errors exceeds the predefined threshold value, for a user.

18. The non-transitory machine-readable information storage medium of claim 17, wherein the at least one processor is further configured to generate another signal for each source end having one or more parameters, upon determining the message signature associated with the signal received by each destination end is valid, and wherein the at least one processor is further configured to log one or more entries associated with the one or more errors and increment the error count, upon determining the error count of the one or more errors does not exceeds the predefined threshold value.

19. The non-transitory machine-readable information storage medium of claim 17, wherein the at least one processor is further configured to transmit the alert associated with the one or more errors to the user, wherein the user corresponds to a pilot or a ground support unit, and wherein the alert comprises one or more instructions such as follow standard operating procedure (SOP) and initiate inspection.

20. The non-transitory machine-readable information storage medium of claim 17, wherein the at least one processor is further configured to:
identify each source end and each destination end within the avionics network with one or more deterministic traffic capabilities;
identify a communication scheme, at least one type for each source end and each destination end, and a critical traffic virtual links for each source end and each destination end; and
add at least one slot in each source end to transmit the signal with the predefined timestamp and at least one slot in each destination end to receive the signal at the predefined timestamp,
wherein the at least one slot in each source end and the at least one slot in each destination end correspond to a specific time interval, logical channel, or frequency range during which the signal is configured to be transmitted from each source end to each destination end.
